(19) United States
(12) Patent Application Publication
(10) Pub. No.: US 2024/0203126 A1
(43) Pub. Date: Jun. 20, 2024

(54) INTELLIGENT PASSENGER INSPECTION CHANNEL SYSTEM AND INTELLIGENT PASSENGER INSPECTION METHOD

(71) Applicants: NUCTECH COMPANY LIMITED, Haidian District (CN); NUCTECH JIANGSU COMPANY LIMITED, Jiangsu (CN); TSINGHUA UNIVERSITY, Haidian District (CN)

(72) Inventors: Zhiqiang CHEN, Haidian District (CN); Li ZHANG, Haidian District (CN); Hu TANG, Haidian District (CN); Yunda SUN, Haidian District (CN); Dong LI, Haidian District (CN); Dan YAN, Haidian District (CN); Yueyi LIU, Haidian District (CN)

(21) Appl. No.: 18/530,332

(22) Filed: Dec. 6, 2023

(30) Foreign Application Priority Data
Dec. 15, 2022 (CN) 202211637862.6

(51) Int. Cl. G06V 20/52; G06V 20/64

(52) U.S. Cl. CPC G06V 20/52; G06V 20/64; G06V 2201/07

(57) ABSTRACT

An intelligent passenger inspection channel system and method are provided. The system includes: a passenger entrance device; a first camera, provided at the passenger entrance device for capturing a first image of a number of passengers going to pass through the device; a luggage inspection device; a second camera, provided at an entrance of the luggage inspection device for capturing a second image of a luggage entering the entrance and a corresponding passenger; a third camera, provided at an exit of the luggage inspection device for capturing a third image of a luggage leaving the exit and a corresponding passenger; a personnel security inspection device; a fifth camera, provided at the personnel security inspection device for capturing a fifth image of an inspector's inspection behavior; and a sixth camera, provided in a passenger inspection channel for capturing a sixth image of an entire travel of a passenger within the channel.

### CROSS-REFERENCE TO RELATED APPLICATIONS

This application claims priority to Chinese Patent Application No. 202211637862.6, filed on Dec. 15, 2022, the disclosure of which is hereby incorporated in its entirety by reference.

### TECHNICAL FIELD

The present disclosure relates to a field of security inspection, and in particular, to an intelligent passenger inspection channel system and an intelligent passenger inspection method.

### BACKGROUND

A passenger inspection channel system refers a system for inspecting passengers and their luggage, so as to achieve supervision and ensure safety. A traditional passenger inspection channel is mainly composed of modules such as personnel ticket verification, X-ray assisted image recognition, personal inspection, and luggage (suitcase) unpacking inspection. Each step of the passenger inspection is basically manually completed, resulting in low efficiency for passenger clearance.

### SUMMARY

In order to solve the aforementioned problems in the prior art, embodiments of the present disclosure propose an intelligent passenger inspection channel system and an intelligent passenger inspection method. The intelligent passenger inspection channel system has the advantages of comprehensive functions, reasonable design, high intelligence, and good travel experience.

As an aspect of the present disclosure, an intelligent passenger inspection channel system is provided, including: a passenger entrance device: a first camera, provided at the passenger entrance device, and configured to capture a first image of a number of passengers going to pass through the passenger entrance device, where the first image serves as an input to a person counting model and a queue time estimation model: a luggage inspection device: a second camera, provided at an entrance of the luggage inspection device, and configured to capture a second image of a luggage entering the entrance and a passenger corresponding to the luggage entering the entrance, where the second image serves as a first input to a person-luggage binding model: a third camera, provided at an exit of the luggage inspection device, and configured to capture a third image of a luggage leaving the exit and a passenger corresponding to the luggage leaving the exit, where the third image serves as a second input to the person-luggage binding model: a fourth camera, provided at the exit of the luggage inspection device, and configured to capture a fourth image of a luggage unpacked for inspection at the exit, where the fourth image serves as an input to an unpacked luggage recognition model: a personnel security inspection device: a fifth camera, provided at the personnel security inspection device, and configured to capture a fifth image of a security inspector's inspection behavior on a passenger, where the fifth image serves as an input to a manual inspection quality control model: a sixth camera, provided in a passenger inspection channel, and configured to capture a sixth image of an entire travel of a passenger within the passenger inspection channel, where the sixth image serves as an input to a behavior recognition model: and a seventh camera, provided in the passenger inspection channel, and configured to capture a seventh image of an entire travel of a passenger within the passenger inspection channel, where the seventh image serves as input to a pedestrian tracking model.

According to the intelligent passenger inspection channel system of the embodiments of the present disclosure, by using the first image as the input to the queue time estimation model, it is possible to help passengers better understand a situation of a queue at the passenger entrance device, which may help the passengers timely adjust their queue plans before clearance and accelerate a clearance speed: by using the second and third images as the inputs to the person-luggage binding model, when a luggage is inspected to have a hidden danger inside and required to be unpacked for inspection, it may help to quickly find the passenger corresponding to the luggage, thereby improving the efficiency of passenger inspection: when a passenger mistakenly picks up someone else's luggage, it may help to track and locate the suspicious individual, so that the luggage may be quickly retrieved and the passenger losses may be reduced: and by using the fourth image as the input to the unpacked luggage recognition model, evidences may be collected throughout the entire luggage unpacking process.

In addition, by using the fifth image as the input to the manual inspection quality control model, it is possible to assist the security inspector in better regulating his/her actions during the personal inspection, ensuring that the specified parts are inspected one by one, and ensuring the customs clearance security. By using the sixth image as the input to the behavior recognition model and the seventh image as the input to the pedestrian tracking model, it is possible to assist the staff in locating a passenger with abnormal behavior quickly, so that measures may be taken timely to help or track the passenger, improving service quality and ensuring the customs clearance security. The intelligent passenger inspection channel system provided by the present disclosure has comprehensive functions and reasonable design, permitting passengers to receive comprehensive assistance from entering the passenger inspection channel to leaving the passenger inspection channel, thereby improving their travel experience.

In some embodiments, the sixth camera and the seventh camera are a same camera, and the sixth image and the seventh image are a same image.

In some embodiments, at least one of the first camera, the second camera, the third camera, the fifth camera and the sixth camera is provided on a truss, where the truss covers the passenger entrance device and the luggage inspection device in a length direction, and covers the personnel security inspection device and the luggage inspection device in a width direction.

In some embodiments, the truss is provided with a plurality of movable lateral beams at intervals in the length direction, and at least one of the first camera, the second camera, the third camera, the fifth camera and the sixth camera is provided on the plurality of movable lateral beams.

In some embodiments, a plurality of movable longitudinal beams at intervals are provided between two of the plurality of movable lateral beams, and at least one of the first camera, the second camera, the third camera, the fifth camera and the sixth camera is provided on the plurality of movable longitudinal beams.

In some embodiments, the truss is provided with a plurality of movable longitudinal beams at intervals in the width direction, and at least one of the first camera, the second camera, the third camera, the fifth camera and the sixth camera is provided on the plurality of movable longitudinal beams.

In some embodiments, a plurality of movable lateral beams at intervals are provided between two of the plurality of movable longitudinal beams, and at least one of the first camera, the second camera, the third camera, the fifth camera and the sixth camera is provided on the plurality of movable lateral beams.

In some embodiments, at least one of the first camera, the second camera, the third camera, the fifth camera and the sixth camera is movable along a height direction of the truss.

In some embodiments, a plurality of fifth cameras are provided at intervals around the personnel security inspection device.

In some embodiments, a plurality of sixth cameras are provided at intervals within the passenger inspection channel, and sixth images captured by the plurality of sixth cameras cover a full range of the passenger inspection channel.

In some embodiments, intelligent passenger inspection channel system further includes a voice prompt device, communicatively connected to the luggage inspection device, where the unpacked package recognition model is preset with a mapping relationship between a suspicious object and a broadcast message, and the voice prompt device plays the broadcast message corresponding to the suspicious object in response to the suspicious object presents in the fourth image.

As another aspect of the present disclosure, an intelligent passenger inspection method is provided, including: acquiring a first image, where the first image shows a number of passengers going to pass through a passenger entrance device: inputting the first image to a person counting model, so as to obtain the number of passengers going to pass through the passenger entrance device: inputting the first image to a queue time estimation model, so as to obtain an estimated queue time: acquiring a second image and a third image, where the second image shows a luggage entering an entrance and a passenger corresponding to the luggage entering the entrance, and the third image shows a luggage leaving an exit and a passenger corresponding to the luggage leaving the exit: inputting the second image and the third image to a person-luggage binding model, so as to obtain information on whether an identity of the passenger corresponding to the luggage leaving the exit is correct: acquiring a fourth image, where the fourth image shows a luggage unpacked for inspection at the exit; inputting the fourth image to an unpacked luggage recognition model, so as to obtain information on whether a suspicious object presents in the luggage unpacked for inspection; acquiring a fifth image, where the fifth image shows an inspection behavior between a passenger and a security inspector: inputting the fifth image to a manual inspection quality control model, so as to obtain feedback information on whether a manual inspection is qualified: acquiring a sixth image, where the sixth image shows an entire travel of a passenger within a passenger inspection channel: inputting the sixth image to a behavior recognition model, so as to obtain feedback information on whether a behavior of the passenger is dangerous: acquiring a seventh image, where the seventh image shows an entire travel of a passenger within the passenger inspection channel: and inputting the seventh image to a pedestrian tracking model, so as to obtain feedback information on whether a behavior complies with regulations.

According to the intelligent passenger inspection method of the embodiments of the present disclosure, by using the first image as the input to the queue time estimation model, it is possible to help passengers better understand a situation of a queue at the passenger entrance device, which may help the passengers timely adjust their queue plans before clearance and accelerate a clearance speed: by using the second and third images as the inputs to the person-luggage binding model, when a luggage is inspected to have a hidden danger inside and required to be unpacked for inspection, it may help to quickly find the passenger corresponding to the luggage, thereby improving the efficiency of passenger inspection: when a passenger mistakenly picks up someone else's luggage, it may help to track and locate the suspicious individual, so that the luggage may be quickly retrieved and the passenger losses may be reduced: and by using the fourth image as the input to the unpacked luggage recognition model, evidences may be collected throughout the entire luggage unpacking process. In addition, by using the fifth image as the input to the manual inspection quality control model, it is possible to assist the security inspector in better regulating his/her actions during the personal inspection, ensuring that the specified parts are inspected one by one, and ensuring the customs clearance security. By using the sixth image as the input to the behavior recognition model and the seventh image as the input to the pedestrian tracking model, it is possible to assist the staff in locating a passenger with abnormal behavior quickly, so that measures may be taken timely to help or track the passenger, improving service quality and ensuring the customs clearance security. The intelligent passenger inspection channel system provided by the present disclosure has comprehensive functions and reasonable design, permitting passengers to receive comprehensive assistance from entering the passenger inspection channel to leaving the passenger inspection channel, thereby improving their travel experience.

Additional aspects and advantages of the present disclosure will be partially provided in the following description, and some will become apparent from the following description, or learned through the practice of the present disclosure.

### BRIEF DESCRIPTION OF DRAWINGS

In order to have a complete understanding of the present disclosure and its advantages, the following description of the accompanying drawings will be combined with and referred to, where

FIG. 1 shows a schematic diagram of a structure of an intelligent passenger inspection channel system according to an embodiment of the present disclosure:

FIG. 2 shows a schematic diagram of a first camera provided at a passenger entrance device according to an embodiment of the present disclosure;

FIG. 3 shows a schematic diagram of a second camera and a third camera which are provided at a luggage inspection device according to an embodiment of the present disclosure:

FIG. 4 shows a schematic diagram of a fifth camera provided at a personnel security inspection device according to an embodiment of the present disclosure:

FIG. 5 shows a schematic diagram of a sixth camera provided at the passenger inspection channel according to an embodiment of the present disclosure:

FIG. 6 shows a schematic diagram of a structure of an intelligent passenger inspection channel system according to an embodiment of the present disclosure:

FIG. 7 shows a schematic diagram of a structure of an intelligent passenger inspection channel system according to an embodiment of the present disclosure; and

FIG. 8 shows a flowchart of an intelligent passenger inspection method according to an embodiment of the present disclosure.

### REFERENCE NUMERAL

intelligent passenger inspection channel system 100, passenger inspection channel 10, luggage 200, passenger entrance device 1, first camera 2, luggage inspection device 3, second camera 4, third camera 5, personnel security inspection device 6, fifth camera 7, sixth camera 8, fourth camera 20, truss 9, lateral beam 91, longitudinal beam 92, length direction F1, width direction F2, and height direction F3.

### DETAILED DESCRIPTION

Embodiments of the present disclosure will be described with reference to the accompanying drawings below. However, it will be understood that these descriptions are only illustrative and not intended to limit the scope of the present disclosure. In addition, in the followings, descriptions of well-known structures and techniques are omitted to avoid unnecessary confusion with the concepts of the present disclosure. In addition, the various embodiments and technical features provided in the present disclosure may be combined with each other in any way.

The terms used herein are only intended to describe specific embodiments of the present disclosure and are not intended to limit the present disclosure. In addition, the terms “including”, “comprising”, etc. used herein indicate the presence of the features, steps, operations, and/or components, but do not exclude the existence or addition of one or more other features, steps, operations, or components. All terms used herein (including technical and scientific terms) have the meanings commonly understood by those skilled in the art, unless otherwise defined. It should be noted that the terms used herein should be interpreted as having a meaning consistent with the context of the present disclosure, and should not be interpreted in an idealized or overly rigid manner.

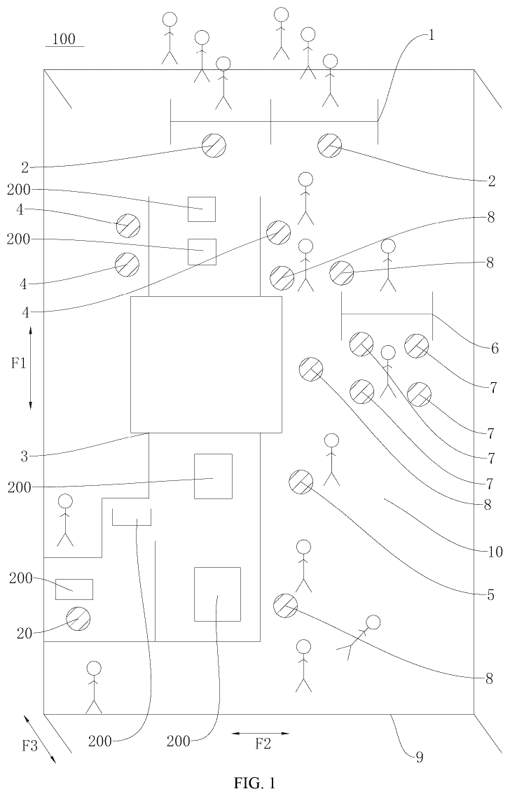

The intelligent passenger inspection channel system 100 and the intelligent passenger inspection method according to the embodiments of the present disclosure are described below with reference to FIGS. 1 to 8.

As shown in FIGS. 1 to 7, the intelligent passenger inspection channel system 100 according to the embodiments of the present disclosure includes a passenger entrance device 1, a first camera 2, a luggage inspection device 3, a second camera 4, a third camera 5, a personnel security inspection device 6, a fifth camera 7, and a sixth camera 8.

Specifically, with reference to FIG. 1, the first camera 2 is provided at the passenger entrance device 1 and configured to capture a first image of the number of passengers going to pass through the passenger entrance device 1, where the first image serves as an input to a person counting model and a queue time estimation model. The second camera 4 is provided at an entrance of the luggage inspection device 3 and configured to capture a second image of a luggage 200 entering the entrance and a passenger corresponding to the luggage entering the entrance, where the second image serves as a first input to a person-luggage binding model. The third camera 5 is provided at the exit of the luggage inspection device 3 and configured to capture a third image of a luggage 200 leaving the exit and a passenger corresponding to the luggage leaving the exit, where the third image serves as a second input to the person-luggage binding model. The fourth camera 20 is provided at the exit of luggage inspection device 3 and configured to capture a fourth image of a luggage 200 unpacked for inspection at the exit, where the fourth image serves as an input to an unpacked luggage recognition model.

The fifth camera 7 is provided at the personnel security inspection device 6 and configured to capture a fifth image showing an inspection behavior between a passenger and a security inspector, where the fifth image serves as an input to a manual inspection quality control model. The sixth camera 8 is provided in a passenger inspection channel 10 and configured to capture a sixth image of an entire travel of a passenger within the passenger inspection channel 10, where the sixth image serves as an input to a behavior recognition model. The seventh camera is provided in the passenger inspection channel 10 and configured to capture a seventh image of an entire travel of a passenger within the passenger inspection channel 10, where the seventh image serves as an input to a pedestrian tracking model.

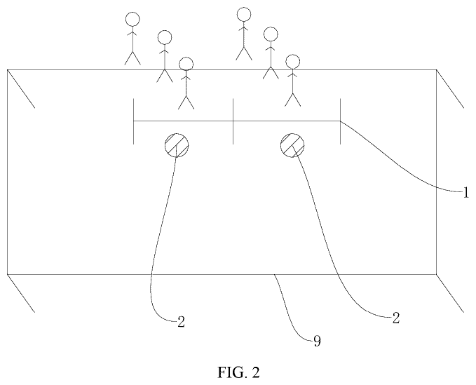

It will be understood that, as shown in FIG. 2, a passenger may enter the passenger inspection channel 10 through the passenger entrance device 1. The first camera 2 is provided at the passenger entrance device 1 to capture the image showing the number of passengers going to pass through the passenger inspection channel 10, which is the first image. The first image serves as the input to the person counting model, so that the person counting model may calculate the number of passengers going to pass through the passenger entrance device 1, thereby outputting the number of passengers going to pass through the passenger entrance device 1 to prompt passengers who are queuing. The first image may also serve as the input to the queue time estimation model, so that the queue time estimation model may analyze the first image to obtain the current number of the passengers who are queuing. Based on the number of the passengers who are queuing and a historical time for a single person to pass through the passenger entrance device 1 or a historical speed at which a single person passes through the passenger entrance device 1, an estimated queue time may be obtained, providing a reference for the passengers who are queuing.

For example, a plurality of passenger entrance devices 1 may be provided, and at least one first camera 2 may be provided at each passenger entrance device 1. Accordingly, the estimated queue time may serve as a prompt for the passengers to choose a faster channel, ensuring a high passing efficiency while improving passengers' travel experience and increasing passenger satisfaction.

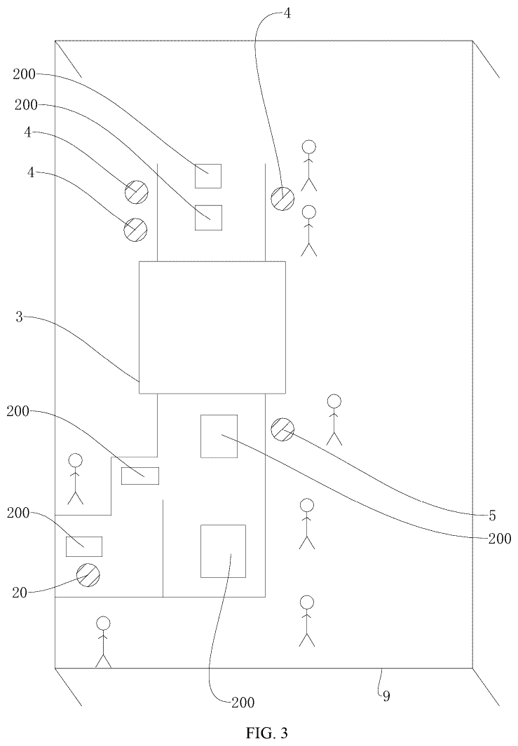

As shown in FIG. 3, after a passenger enters the passenger entrance device 1, a luggage 200 may be sent to the luggage inspection device 3 through the entrance of the luggage inspection device 3. A second camera 4 may be provided at the entrance of the luggage inspection device 3 to capture an image of the luggage 200 and the passenger corresponding to the luggage 200 when the passenger places the luggage 200, which is the second image. The second image serves as an input to the person-luggage binding model, namely the first input to the person-luggage binding model, so that the person-luggage binding model may obtain a mapping relationship between the luggage 200 and the passenger by analyzing the second image.

The third camera 5 is provided at the exit of luggage inspection device 3 to capture an image of a luggage 200 leaving the exit, which is the third image. The third image serves as an input to the person-luggage binding model, namely the second input to the person-luggage binding model, so that the person-luggage binding model may analyze the third image to match the luggage 200 in the third image with a luggage 200 in a luggage information library of the person-luggage binding model. When a luggage 200 in the luggage information library is matched with the luggage 200 in the third image, the passenger corresponding to the luggage 200 may be quickly located by using the mapping relationship between the luggage 200 and the passenger.

Therefore, when a passenger mistakenly picks up someone else's luggage 200, it may help to track and locate the suspicious individual, so that the luggage 200 may be quickly retrieved and the passenger losses may be reduced. When a luggage 200 is inspected to have a hidden danger inside and required to be unpacked for inspection, it may help to quickly find the passenger corresponding to the luggage 200, thereby improving the efficiency of the passenger inspection.

The luggage inspection device 3 may recognize a suspicious object by using a target recognition technology of the unpacked luggage recognition model, and the luggage with the recognized suspicious object may be automatically sorted to an luggage unpacking station for an manual inspection through the exit of the luggage inspection device 3. The luggage 200 required to be the manually inspected may be tracked by the fourth camera 20, and a fourth image of an entire luggage unpacking process may be captured in accordance with relevant laws and regulations, such as for a video evidence collection. The fourth image may serve as an input to the unpacked luggage recognition model.

In an embodiment of the present disclosure, the intelligent passenger inspection channel system may further include a voice prompt device, which is communicatively connected to the luggage inspection device, where the unpacked package recognition model is preset with a mapping relationship between a suspicious object and a broadcast message, and the voice prompt device plays the broadcast message corresponding to the suspicious object when the suspicious object presents in the fourth image. For example, the voice prompt device may play a prompt of which law(s) and regulation(s) are violated, facilitating communication between the staff and the passenger.

As an example, when a passenger's luggage passes through luggage inspection device 3 (an X-ray machine within the luggage inspection device 3), items in the luggage 200 may be recognized by using an algorithm. When contraband appears, a type and amount of the contraband may be indicated, and an instruction to send the illegal luggage 200 to the luggage unpacking station for manual inspection may be sent out. If there is indeed contraband in the luggage 200, the contraband will be detained, otherwise the luggage 200 will be released. When an manual inspection is performed, the algorithm may query a database and provide specific legal provisions that are violated based on the type and amount of the contraband, thereby improving the communication efficiency.

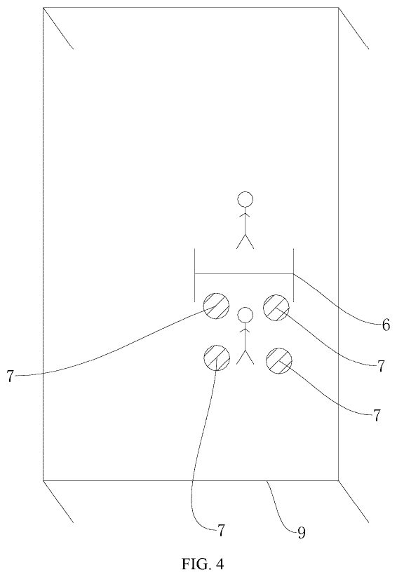

As shown in FIG. 4, while the luggage 200 is being inspected in the luggage inspection device 3, the passenger is required to be inspected at the personnel security inspection device 6. The personnel security inspection device 6 may be a security inspection door, which may or may not have a security function. When the passenger passes through the personnel security inspection device 6, the passenger is also required to manually inspected by a security inspector. The fifth camera 7 is provided at the personnel security inspection device 6, which may capture an image of the security inspector's inspection behavior on the passenger, which is the fifth image. The fifth image serves as an input to the manual inspection quality control model, so that the manual inspection quality control model may analyze the fifth image to obtain the security inspector's inspection actions on the passenger.

In this way, the inspection actions may be compared with standard inspection actions in the manual inspection quality control model. When the inspection actions match with the standard inspection actions, that is, when the security inspector has checked every specified part of the passenger, it is prompted that the inspection actions are standard-compliant: if one or more specified parts are not inspected, it is prompted that the inspection actions are not standard-compliant. Also, the inspection actions may be scored, and there is no limit on a specific result output by the manual inspection quality control model. The quality of the manual inspection may be improved by using the manual inspection quality control model.

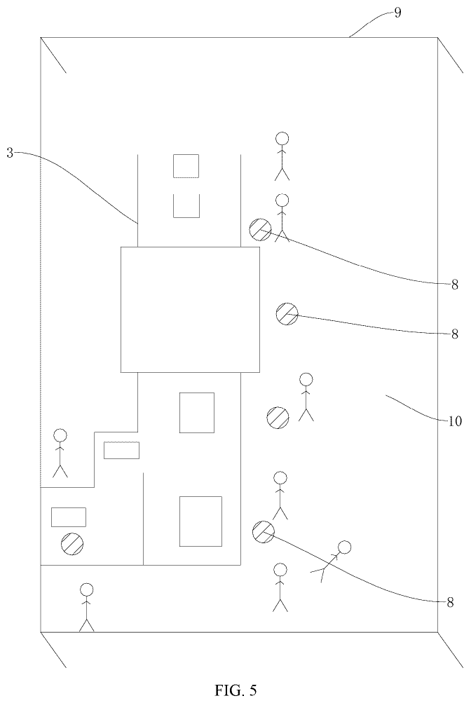

As shown in FIG. 5, the sixth camera 8 provided in the passenger inspection channel 10 may capture an image of an entire travel of a passenger within the passenger inspection channel 10, which is the sixth image. The sixth image serves as an input to the behavior recognition model, so that the behavior recognition model may analyze the sixth image to determine whether a passenger has behaviors such as falling, fighting, or violations throughout the entire travel within the passenger inspection channel 10, which may facilitate the staff to take timely measures to maintain order and safety at the passenger inspection site, thereby ensuring safe passage of passengers and improving the service quality of the passenger inspection.

The seventh camera provided inside the passenger inspection channel 10 may capture an image of an entire travel of a passenger within the passenger inspection channel 10, which is the seventh image. The seventh image serves as an input to the pedestrian tracking model, so as to track a suspicious individual. Once a suspicious individual engages in dangerous behavior, it may be convenient for the staff to take timely measures to maintain order and safety at the passenger inspection site, thereby ensuring safe passage of passengers and improving the service quality of the passenger inspection.

According to the intelligent passenger inspection channel system 100 provided by the embodiments of the present disclosure, by using the first image as the input to the queue time estimation model, it is possible to help passengers better understand a situation of a queue at the passenger entrance device 1, which may help the passengers timely adjust their queue plans before clearance and accelerate a clearance speed: by using the second and third images as the inputs to the person-luggage binding model, when a luggage 200 is inspected to have a hidden danger inside and required to be unpacked for inspection, it may help to quickly find the passenger corresponding to the luggage 200, thereby improving the efficiency of passenger inspection: when a passenger mistakenly picks up someone else's luggage 200, it may help to track and locate the suspicious individual, so that the luggage 200 may be quickly retrieved and the passenger losses may be reduced: and by using the fourth image as the input to the unpacked luggage recognition model, evidences may be collected throughout the entire luggage unpacking process.

In addition, by using the fifth image as the input to the manual inspection quality control model, it is possible to assist the security inspector in better regulating his/her actions during the personal inspection, ensuring that the specified parts are inspected one by one, and ensuring the customs clearance security. By using the sixth image as the input to the behavior recognition model and the seventh image as the input to the pedestrian tracking model, it is possible to assist the staff in locating a passenger with abnormal behavior quickly, so that measures may be taken timely to help or track the passenger, improving service quality and ensuring the customs clearance security. The intelligent passenger inspection channel system 100 provided by the present disclosure has comprehensive functions and reasonable design, permitting passengers to receive comprehensive assistance from entering the passenger inspection channel 10 to leaving the passenger inspection channel 10, thereby improving their travel experience.

According to some embodiments of the present disclosure, the person counting model may take the first image as its input, and output the current number of the passengers who are queuing at the entrance device 1 by using relevant algorithms such as a face recognition algorithm and a head recognition algorithm.

According to some embodiments of the present disclosure, the queue time estimation model takes effective variables such as the number of the passengers who are queuing in the first image, the speed at which the passengers pass through the entrance device 1 and/or the speed at which the passengers pass through the personnel security inspection device 6 as the inputs that may be used to estimate the queue time. By calculating or using a deep learning method, the queue time may be output.

According to some embodiments of the present disclosure, the entrance device 1 is provided with a face recognition model, which takes a camera image and a passenger identity information database as its inputs. Feedback information on whether the passenger is unified with his/her identification may be output by using the face recognition algorithm.

According to some embodiments of the present disclosure, an operation of the person-luggage binding model may be divided into three stages.

In a first stage, the second image serves as an input, and algorithms such as a face recognition algorithm, a luggage inspection algorithm, a pedestrian inspection algorithm, a pedestrian tracking algorithm, a pedestrian re-recognition algorithm, a luggage tracking algorithm, and a luggage re-recognition algorithm are combined to output a database of person, face and luggage.

In a second stage, an image captured by an X-ray machine serves as an input, and a target recognition algorithm is used to output an X-ray machine recognition result and an X-ray machine image.

In a third stage, the database of person, face and luggage, the X-ray machine recognition result and the X-ray machine image serve as inputs, and a target recognition algorithm is used to output an information library of person, face, luggage, X-ray machine image and X-ray machine recognition.

According to some embodiments of the present disclosure, the unpacked luggage recognition model takes the fourth image, the image captured by the X-ray machine and a database of law provisions corresponding to the contraband as inputs, and outputs the location, type and amount of the contraband and violated laws and regulations corresponding to the contraband by using a target recognition algorithm.

According to some embodiments of the present disclosure, the manual inspection quality control model takes the fifth image as an input and outputs information on whether the security inspector's inspection complies with the rules by using algorithms such as a pedestrian inspection algorithm, a pose estimation algorithm, and an attribute recognition algorithm.

According to some embodiments of the present disclosure, the behavior recognition model takes the sixth image as an input and outputs information on whether there is a specific behavior such as falling, fighting, violations, etc. by using a behavior recognition algorithm.

According to some embodiments of the present disclosure, the pedestrian tracking model takes the seventh image as an input and outputs location information of a tracked person by using a pedestrian tracking algorithm.

In some embodiments of the present disclosure, the sixth camera and the seventh camera may be the same camera, and the sixth image and the seventh image may be the same image. In this way, it is possible to reduce the number of cameras installed and save costs.

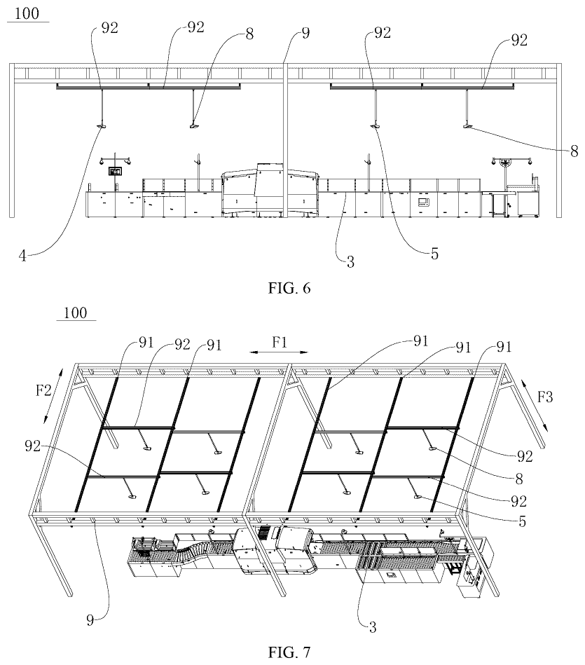

In some embodiments of the present disclosure, as shown in FIGS. 6 and 7, at least one of the first camera 2, the second camera 4, the third camera 5, the fifth camera 7, and the sixth camera 8 is provided on a truss 9, where the truss 9 covers the passenger entrance device 1 and the luggage inspection device 3 in a length direction F1, and covers the personnel security inspection device 6 and the luggage inspection device 3 in a width direction F2. It will be understood that the truss 9 may be a support frame for holding at least one of the first camera 2, the second camera 4, the third camera 5, the fifth camera 7 and the sixth camera 8.

Since the truss 9 covers the passenger entrance device 1 and the luggage inspection device 3 in the length direction F1, and the personnel security inspection device 6 and the luggage inspection device 3 in the width direction F2, the first camera 2 provided on the truss 9 may capture an image at the passenger entrance device 1. That is, an image shows the number of passengers going to pass through the passenger entrance device 1 may be captured. Also, the second camera 4 provided on the truss 9 may capture an image at the entrance of the luggage inspection device 3, that is, an image of a luggage 200 at the entrance and a passenger corresponding to the luggage 200 at the entrance may be captured. The third camera 5 provided on the truss 9 may capture an image at the exit of the luggage inspection device 3, that is, an image of a luggage 200 at the exit and a passenger corresponding to the luggage 200 at the exit may be captured.

The fifth camera 7 provided on the truss 9 may capture an image at the personnel security inspection device 6, that is, an image of manual inspection actions of a security inspector performing security inspection on a passenger may be captured. The sixth camera 8 provided on the truss 9 may capture an image of a full range inside a security inspection channel, that is, an image showing an entire travel of a passenger within a security inspection channel may be captured. As such, the truss 9 according to the present disclosure may facilitate the installation and image capturing of the first camera 2, the second camera 4, the third camera 5, the fifth camera 7 and the sixth camera 8.

In some embodiments of the present disclosure, a support member may further be provided at the entrance of the luggage inspection device 3, and the second camera 4 may be installed on the support member. The support member may be placed on the ground, or the support member may be installed on the luggage inspection device 3. The second image captured by the second camera 4 may also be used for face recognition.

According to some embodiments of the present disclosure, as shown in FIGS. 6 and 7, the truss 9 is provided with a plurality of movable lateral beams 91 at intervals in the length direction F1, and at least one of the first camera 2, the second camera 4, the third camera 5, the fifth camera 7 and the sixth camera 8 is provided on the plurality of movable lateral beams 91. As such, when installing at least one of the first camera 2, the second camera 4, the third camera 5, the fifth camera 7 and the sixth camera 8, a position of the camera in the length direction F1 of the truss 9 may be adjusted by adjusting a position of the lateral beam 91 in the length direction F1 of the truss 9. After adjusting the position, that is, when at least one of the first camera 2, the second camera 4, the third camera 5, the fifth camera 7 and the sixth camera 8 is adjusted to an optimal shooting position, the lateral beam(s) 91 may be fixed at the adjusted position(s) by fixing it by means of buckle connection, bolt connection, etc., so as to fix the camera.

According to some embodiments of the present disclosure, as shown in FIGS. 6 and 7, a plurality of movable longitudinal beams 92 at intervals are provided between two lateral beams 91. At least one of the first camera 2, the second camera 4, the third camera 5, the fifth camera 7 and the sixth camera 8 is provided on the plurality of movable longitudinal beams 92. As such, when installing at least one of the first camera 2, the second camera 4, the third camera 5, the fifth camera 7 and the sixth camera 8, the position of the camera in the length direction F1 of the truss 9 may be adjusted by adjusting the position of the lateral beam 91 in the length direction F1 of the truss 9, and the position of the camera in the width direction F2 of the truss 9 may be adjusted by adjusting the position of the longitudinal beam 92 in the width direction F2 of the truss 9. After adjusting the position, that is, when at least one of the first camera 2, the second camera 4, the third camera 5, the fifth camera 7 and the sixth camera 8 is adjusted to an optimal shooting position, the lateral beam(s) 91 and longitudinal beam(s) 92 may be fixed at their respective adjusted positions by fixing them by means of buckle connection, bolt connection, etc., so as to fix the camera.

In some embodiments of the present disclosure, as shown in FIGS. 6 and 7, the truss 9 is provided with a plurality of movable longitudinal beams 92 at intervals in the width direction F2, and at least one of the first camera 2, the second camera 4, the third camera 5, the fifth camera 7 and the sixth camera 8 is provided on the plurality of movable longitudinal beams 92. Therefore, when installing at least one of the first camera 2, the second camera 4, the third camera 5, the fifth camera 7 and the sixth camera 8, a position of the camera in the width direction F2 of the truss 9 may be adjusted by adjusting a position of a longitudinal beam 92 in the width direction F2 of the truss 9. After adjusting the position, that is, when at least one of the first camera 2, the second camera 4, the third camera 5, the fifth camera 7 and the sixth camera 8 is adjusted to an optimal shooting position, the longitudinal beam(s) 92 may be fixed at the adjusted position by fixing it by means of buckle connection, bolt connection, etc., so as to fix the camera.

In some embodiments of the present disclosure, as shown in FIGS. 6 and 7, a plurality of movable lateral beams 91 at intervals are provided between two longitudinal beams 92, and at least one of the first camera 2, the second camera 4, the third camera 5, the fifth camera 7 and the sixth camera 8 is provided on the plurality of movable lateral beams 91. As such, when installing at least one of the first camera 2, the second camera 4, the third camera 5, the fifth camera 7 and the sixth camera 8, a position of the camera in the width direction F2 of the truss 9 may be adjusted by adjusting a position of a longitudinal beam 92 in the width direction F2 of the truss 9, and a position of the camera in the length direction F1 of the truss 9 may be adjusted by adjusting a position of the lateral beam 91 in the length direction F1 of the truss 9. After adjusting the position, that is, when at least one of the first camera 2, the second camera 4, the third camera 5, the fifth camera 7 and the sixth camera 8 is adjusted to an optimal shooting position, the lateral beam(s) 91 and longitudinal beam(s) 92 may be fixed at their respective adjusted positions by means of buckle connection, bolt connection, etc., so as to fix the camera.

According to some embodiments of the present disclosure, as shown in FIGS. 6 and 7, at least one of the first camera 2, the second camera 4, the third camera 5, the fifth camera 7 and the sixth camera 8 is movable along the height direction F3 of the truss 9. As such, it may facilitate an adjustment of a position of at least one of the first camera 2, the second camera 4, the third camera 5, the fifth camera 7 and the sixth camera 8 in the height direction F3 of the truss 9, thereby facilitating the adjustment of a shooting angle and a shooting range. In this way, the captured images may have high usability, which may in turn facilitate the achievement of functions of the queue time estimation model, the person-luggage binding model, the manual inspection quality control model and the behavior recognition model.

In some embodiments of the present disclosure, as shown in FIG. 4, a plurality of fifth cameras 7 are provided at intervals around the personnel security inspection device 6. In this way, the plurality of fifth cameras 7 may capture images of the manual inspection actions of the security inspector towards the passenger from a plurality of angles, which may obtain the manual inspection actions comprehensively, thereby reducing the problem that the captured image does not show all the manual inspection actions due to occlusion and providing a better input to the manual inspection quality control model.

In some embodiments of the present disclosure, as shown in FIG. 5, a plurality of sixth cameras 8 are provided at intervals within the passenger inspection channel 10, and the sixth images captured by the plurality of sixth cameras 8 cover a full range of the passenger inspection channel 10. As such, the behavior recognition model may analyze the images showing the full range of the passenger inspection channel 10, so as to obtain information on whether a passenger has behaviors such as falling, fighting, or violations throughout the entire travel within the passenger inspection channel 10. This may facilitate the staff to take timely measures to maintain order and safety at the passenger inspection site, thereby ensuring safe passage of passengers and improving the service quality of the passenger inspection.

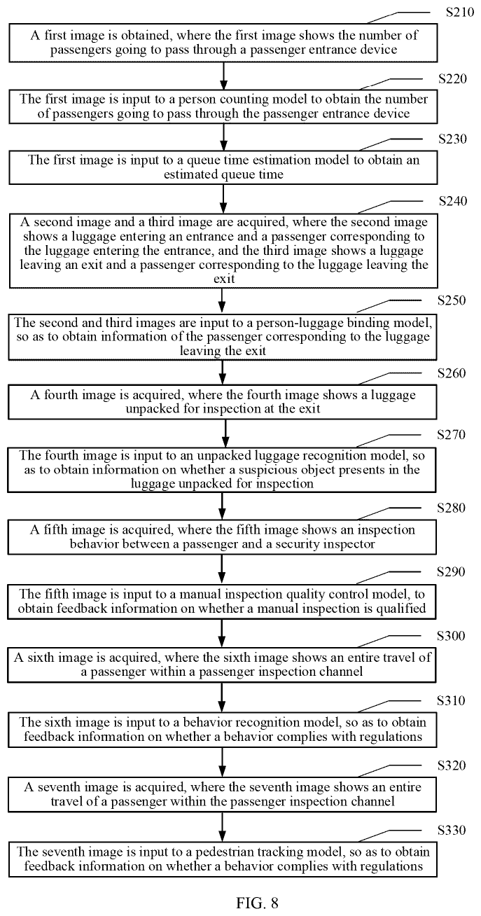

As shown in FIG. 8, the intelligent passenger inspection method according to the embodiments of the present disclosure includes operations S210 to S280.

In operation S210, a first image is obtained, where the first image shows the number of passengers going to pass through a passenger entrance device.

In operation S220, the first image is input to a person counting model to obtain the number of passengers going to pass through the passenger entrance device.

In operation S230, the first image is input to a queue time estimation model to obtain an estimated queue time.

In operation S240, a second image and a third image are acquired, where the second image shows a luggage entering an entrance and a passenger corresponding to the luggage entering the entrance, and the third image shows a luggage leaving an exit and a passenger corresponding to the luggage leaving the exit.

In operation S250, the second and third images are input to a person-luggage binding model, so as to obtain information on whether an identity of the passenger corresponding to the luggage leaving the exit is correct.

In operation S260, a fourth image is acquired, where the fourth image shows a luggage unpacked for inspection at the exit.

In operation S270, the fourth image is input to an unpacked luggage recognition model, so as to obtain information on whether a suspicious object presents in the luggage unpacked for inspection.

In operation S280, a fifth image is acquired, where the fifth image shows an inspection behavior between a passenger and a security inspector.

In operation S290, the fifth image is input to a manual inspection quality control model, so as to obtain feedback information on whether a manual inspection is qualified.

In operation S300, a sixth image is acquired, where the sixth image shows an entire travel of a passenger within a passenger inspection channel.

In operation S310, the sixth image is input to a behavior recognition model, so as to obtain feedback information on whether a behavior of the passenger is dangerous.

In operation S320, a seventh image is acquired, where the seventh image shows an entire travel of a passenger within the passenger inspection channel.

In operation S330, the seventh image is input to a pedestrian tracking model, so as to obtain feedback information on whether a behavior complies with regulations.

According to the intelligent passenger inspection method of the embodiments of the present disclosure, by using the first image as the input to the queue time estimation model, it is possible to help passengers better understand a situation of a queue at the passenger entrance device, which may help the passengers timely adjust their queue plans before clearance and accelerate a clearance speed: by using the second and third images as the inputs to the person-luggage binding model, when a luggage is inspected to have a hidden danger inside and required to be unpacked for inspection, it may help to quickly find the passenger corresponding to the luggage, thereby improving the efficiency of passenger inspection: when a passenger mistakenly picks up someone else's luggage, it may help to track and locate the suspicious individual, so that the luggage may be quickly retrieved and the passenger losses may be reduced: and by using the fourth image as the input to the unpacked luggage recognition model, evidences may be collected throughout the entire luggage unpacking process.

In addition, by using the fifth image as the input to the manual inspection quality control model, it is possible to assist the security inspector in better regulating his/her actions during the personal inspection, ensuring that the specified parts are inspected one by one, and ensuring the customs clearance security: By using the sixth image as the input to the behavior recognition model and the seventh image as the input to the pedestrian tracking model, it is possible to assist the staff in locating a passenger with abnormal behavior quickly, so that measures may be taken timely to help or track the passenger, improving service quality and ensuring the customs clearance security: The intelligent passenger inspection channel system provided by the present disclosure has comprehensive functions and reasonable design, permitting passengers to receive comprehensive assistance from entering the passenger inspection channel to leaving the passenger inspection channel, thereby improving their travel experience.

In the description of the present disclosure, it should be understood that the terms “center”, “longitudinal”, “lateral”, “length”, “width”, “thickness”, “up”, “down”, “front”, “back”, “left”, “right”, “vertical”, “horizontal”, “top”, “bottom”, “inside”, “outside”, “clockwise”, “counterclockwise”, “axial”, “radial”, “circumferential”, etc. are used to indicate an orientation or position relationship based on the orientation or position relationship shown in the accompanying drawings, and are only for ease of description and simplifying the present disclosure, and are not to indicate or imply that the device or component referred to necessarily have a specific orientation, be constructed and operated in a specific orientation, and therefore should not be understood as a limitation on the present disclosure.

In the description of the present disclosure, it should be noted that unless otherwise specified and limited, the terms “installation”, “connection”, and “connection” should be understood broadly, such as a fixed connection, a detachable connection, or an integral connection: a mechanical connection or an electrical connection: a directly connection, an indirectly connection through an intermediate medium, or an internal connection between two components. For those of ordinary skill in the art, the specific meanings of the above terms in the present disclosure may be understood in specific circumstances.

In the description of the present specification, the reference terms “one embodiment”, “some embodiments”, “illustrative embodiments”, “an example”, “a specific example”, or “some examples” refer to the specific features, structures, materials, or features described in conjunction with the embodiment or example being included in at least one embodiment or example of the present disclosure. In the present specification, the schematic expressions of the above terms do not necessarily refer to the same embodiments or examples. Moreover, the specific features, structures, materials, or features described may be combined in an appropriate manner in any one or more embodiments or examples.

Although embodiments of the present disclosure have been shown and described, those of ordinary skill in the art will understand that various changes, modifications, substitutions, and variations may be made to these embodiments without departing from the principle and spirit of the present disclosure. The scope of the present disclosure is limited by the claims and their equivalents

Those skilled in the art will understand that the features recorded in the various embodiments and/or claims of the present disclosure may be combined or integrated in various ways, even if such combinations or integrations are not explicitly recorded in the present disclosure. Specifically, without departing from the spirit and teachings of the present disclosure, the features recorded in the various embodiments and/or claims of the present disclosure may be combined and/or integrated in various ways. All these combinations and/or integrations fall within the scope of the present disclosure.

Although the present disclosure has been illustrated and described with reference to specific exemplary embodiments of the present disclosure, those skilled in the art will understand that various changes in form and details may be made to the present disclosure without departing from the spirit and scope of the disclosure limited by the accompanying claims and their equivalents. Therefore, the scope of the present disclosure should not be limited to the aforementioned embodiments, but should be determined not only by the accompanying claims, but also by the equivalents of the accompanying claims.

What is claimed is:

1. An intelligent passenger inspection channel system, comprising:
a passenger entrance device;
a first camera, provided at the passenger entrance device, and configured to capture a first image of a number of passengers going to pass through the passenger entrance device, wherein the first image serves as an input to a person counting model and a queue time estimation model;
a luggage inspection device;
a second camera, provided at an entrance of the luggage inspection device, and configured to capture a second image of a luggage entering the entrance and a passenger corresponding to the luggage entering the entrance, wherein the second image serves as a first input to a person-luggage binding model;
a third camera, provided at an exit of the luggage inspection device, and configured to capture a third image of a luggage leaving the exit and a passenger corresponding to the luggage leaving the exit, wherein the third image serves as a second input to the person-luggage binding model;
a fourth camera, provided at the exit of the luggage inspection device, and configured to capture a fourth image of a luggage unpacked for inspection at the exit, wherein the fourth image serves as an input to an unpacked luggage recognition model;
a personnel security inspection device;
a fifth camera, provided at the personnel security inspection device, and configured to capture a fifth image of a security inspector's inspection behavior on a passenger, wherein the fifth image serves as an input to a manual inspection quality control model;
a sixth camera, provided in a passenger inspection channel, and configured to capture a sixth image of an entire travel of a passenger within the passenger inspection channel, wherein the sixth image serves as an input to a behavior recognition model; and
a seventh camera, provided in the passenger inspection channel, and configured to capture a seventh image of an entire travel of a passenger within the passenger inspection channel, wherein the seventh image serves as input to a pedestrian tracking model.

2. The intelligent passenger inspection channel system according to claim 1, wherein the sixth camera and the seventh camera are a same camera, and the sixth image and the seventh image are a same image.

3. The intelligent passenger inspection channel system according to claim 1, wherein at least one of the first camera, the second camera, the third camera, the fifth camera and the sixth camera is provided on a truss, wherein the truss covers the passenger entrance device and the luggage inspection device in a length direction, and covers the personnel security inspection device and the luggage inspection device in a width direction.

4. The intelligent passenger inspection channel system according to claim 3, wherein the truss is provided with a plurality of movable lateral beams at intervals in the length direction, and at least one of the first camera, the second camera, the third camera, the fifth camera and the sixth camera is provided on the plurality of movable lateral beams.

5. The intelligent passenger inspection channel system according to claim 4, wherein a plurality of movable longitudinal beams at intervals are provided between two of the plurality of movable lateral beams, and at least one of the first camera, the second camera, the third camera, the fifth camera and the sixth camera is provided on the plurality of movable longitudinal beams.

6. The intelligent passenger inspection channel system according to claim 3, wherein the truss is provided with a plurality of movable longitudinal beams at intervals in the width direction, and at least one of the first camera, the second camera, the third camera, the fifth camera and the sixth camera is provided on the plurality of movable longitudinal beams.

7. The intelligent passenger inspection channel system according to claim 6, wherein a plurality of movable lateral beams at intervals are provided between two of the plurality of movable longitudinal beams, and at least one of the first camera, the second camera, the third camera, the fifth camera and the sixth camera is provided on the plurality of movable lateral beams.

8. The intelligent passenger inspection channel system according to claim 3, wherein at least one of the first camera, the second camera, the third camera, the fifth camera and the sixth camera is movable along a height direction of the truss.

9. The intelligent passenger inspection channel system according to claim 1, wherein a plurality of fifth cameras are provided at intervals around the personnel security inspection device.

10. The intelligent passenger inspection channel system according to claim 1, wherein a plurality of sixth cameras are provided at intervals within the passenger inspection channel, and sixth images captured by the plurality of sixth cameras cover a full range of the passenger inspection channel.

11. The intelligent passenger inspection channel system according to claim 1, further comprising:
a voice prompt device, communicatively connected to the luggage inspection device, wherein the unpacked package recognition model is preset with a mapping relationship between a suspicious object and a broadcast message, and the voice prompt device plays the broadcast message corresponding to the suspicious object in response to the suspicious object presents in the fourth image.

12. An intelligent passenger inspection method, comprising:
acquiring a first image, wherein the first image shows a number of passengers going to pass through a passenger entrance device;
inputting the first image to a person counting model, so as to obtain the number of passengers going to pass through the passenger entrance device;
inputting the first image to a queue time estimation model, so as to obtain an estimated queue time;
acquiring a second image and a third image, wherein the second image shows a luggage entering an entrance and a passenger corresponding to the luggage entering the entrance, and the third image shows a luggage leaving an exit and a passenger corresponding to the luggage leaving the exit;
inputting the second image and the third image to a person-luggage binding model, so as to obtain information on whether an identity of the passenger corresponding to the luggage leaving the exit is correct;
acquiring a fourth image, wherein the fourth image shows a luggage unpacked for inspection at the exit;
inputting the fourth image to an unpacked luggage recognition model, so as to obtain information on whether a suspicious object presents in the luggage unpacked for inspection;
acquiring a fifth image, wherein the fifth image shows an inspection behavior between a passenger and a security inspector;
inputting the fifth image to a manual inspection quality control model, so as to obtain feedback information on whether a manual inspection is qualified;
acquiring a sixth image, wherein the sixth image shows an entire travel of a passenger within a passenger inspection channel;
inputting the sixth image to a behavior recognition model, so as to obtain feedback information on whether a behavior of the passenger is dangerous;
acquiring a seventh image, wherein the seventh image shows an entire travel of a passenger within the passenger inspection channel; and
inputting the seventh image to a pedestrian tracking model, so as to obtain feedback information on whether a behavior complies with regulations.
